(19) United States
(12) Patent Application Publication
(10) Pub. No.: US 2023/0184405 A1
(43) Pub. Date: Jun. 15, 2023

(54) FLAT LAMP AND LIGHTING MODULE THEREOF

(71) Applicant: ZHONGSHAN DASHAN PHOTOGRAPHIC EQUIPMENT CO., LTD., ZHONGSHAN (CN)

(72) Inventors: XIHUA ZHU, ZHONGSHAN (CN); JINHUA DUAN, ZHONGSHAN (CN)

(21) Appl. No.: 17/903,071

(22) Filed: Sep. 6, 2022

(30) Foreign Application Priority Data
Dec. 10, 2021 (CN) 202111506769.7
Aug. 26, 2022 (CN) 202211034078.6

(51) Int. Cl. F21V 5/00

(52) U.S. Cl. CPC F21V 5/007; F21Y 2113/10

(57) ABSTRACT

A flat lamp includes a substrate, a lighting module, and a lens. The lighting module includes a plurality of lighting members arranged in a matrix on the substrate. Each of the lighting members includes a plurality of lighting elements for emitting lights of different colors, and neighboring lighting members which are located at corners of a regular polygon are arranged in a manner of a rotation matrix. The lens covers the lighting members, and includes a flat emitting portion through which the lights of the lighting elements pass to the outside.

### CROSS-REFERENCE TO RELATED APPLICATIONS

This application claims priorities to Chinese Patent Application No. 202111506769.7, filed on Dec. 10, 2021 and Chinese Patent Application No. 202211034078.6, filed on Aug. 26, 2022, the entire contents of which are hereby incorporated by reference.

### TECHNICAL FIELD

The present application relates to the technical field of illumination, and in particular to a flat lamp and a lighting module thereof.

### BACKGROUND

Flat lamps, such as LED flat lamps, have the advantages of thin size, high brightness, long life and easy installation, and are widely used in home and office.

An LED flat lamp generally includes a substrate, a plurality of LEDs mounted on the substrate and a lens covering the LEDs. The LEDs are arranged in a parallel matrix on the substrate, and the orientation and light-emitting directions of the LEDs are the same. During operation of the flat lamp, lights generated by the LEDs pass through the lens to the outside. When the lights enter and exit the lens, it will be refracted in the same direction, resulting in uneven light spots and affecting the lighting effect.

### SUMMARY

Regarding the abovementioned problems of the related art, the present application provides a flat lamp and a lighting module to solve the problem of uneven light spots.

In one aspect, an embodiment of the present application provides a lighting module that includes a substrate and a plurality of lighting members arranged in a matrix on the substrate. Each of the lighting members includes a plurality of lighting elements for emitting lights of different colors. Neighboring lighting members which cooperatively define a regular polygon are arranged in a manner of a rotation matrix.

In some embodiments, each four neighboring lighting members which cooperatively define a square are arranged in a manner of a rotation matrix.

In some embodiments, an orientation of the lighting elements of one lighting member rotates 90 degrees relative to that of the lighting elements of the neighboring lighting member.

In some embodiments, the lighting elements of the lighting member includes a first lighting element for emitting warm light and/or a second lighting element for emitting cool white light.

In some embodiments, the lighting elements of the lighting member further includes at least one of a third lighting element for emitting green light, a fourth lighting element for emitting red light and a fifth lighting element for emitting blue light.

In another aspect, an embodiment of the present application provides a flat lamp including a plurality of lighting members arranged in a matrix. Each of the lighting members includes a plurality of lighting elements for emitting lights of different colors. The lighting elements of each of the lighting members are arranged in a line. For each two neighboring lighting members, an orientation of the lighting elements of one lighting member is different from that of the lighting elements of the other lighting member.

In some embodiments, for two neighboring lighting members in each column of the matrix, the orientation direction of the lighting elements of one lighting member is perpendicular to that of the lighting elements of the other lighting member.

In some embodiments, for two neighboring lighting members in each row of the matrix, the orientation of the lighting elements of one lighting member is perpendicular to that of the lighting elements of the other lighting member.

In some embodiments, for neighboring lighting members which cooperatively define a regular polygon, the orientations of the lighting elements of the lighting members change continuously along the peripheral direction of the regular polygon.

In some embodiments, for four neighboring lighting members which cooperatively define a square, the orientation of the lighting elements of each lighting member is different from that of the other three lighting members.

In some embodiments, for neighboring lighting members which cooperatively define a rectangle, the orientation of the lighting elements of each lighting member rotates 90 degrees relative to that of the lighting elements of neighboring lighting member along the peripheral direction of the rectangle.

In some embodiments, the lighting elements of the lighting member are LED dies, and include a first lighting element for emitting warm light and/or a second lighting element for emitting cool white light.

In some embodiments, the lighting elements of the lighting member further include at least one of a third lighting element for emitting green light, a fourth lighting element for emitting red light and a fifth lighting element for emitting blue light.

In another aspect, an embodiment of the present application provides a flat lamp that includes a substrate, a plurality of lighting members arranged in a matrix on the substrate, and a lens covering the lighting members. Each of the lighting members includes a plurality of lighting elements for emitting lights of different colors. Neighboring lighting members which are located at corners of a regular polygon are arranged in a manner of a rotation matrix. The lens includes a flat emitting portion through which the lights of the lighting elements pass to the outside.

In some embodiments, the lens further includes a plurality of reflecting portions protruding from an inner side of the emitting portion towards the substrate, and each of the reflecting portions defines a groove receiving one of the lighting members.

In some embodiments, an outer side of the emitting portion facing the outside is fish scale shaped.

In some embodiments, an inner surface of the reflecting portion at a bottom of the groove is convex towards the lighting member.

In some embodiments, an inner circumferential surface of the reflecting portion surrounding the groove expands gradually along a direction towards the lighting member; and an outer circumferential surface of the reflecting portion expands gradually along a direction away from the lighting member.

In some embodiments, the outer circumferential surface of the reflecting portion is bowl-shaped, and the inner circumferential surface of the reflecting portion is conical-shaped.

In some embodiments, the lens is a total internal reflection lens or a convex lens.

The above technical solutions have the following beneficial effects: the lighting members arranged in a manner of a rotation matrix, each of the lighting members includes a plurality of lighting elements for emitting lights of different colors, and neighboring lighting members which cooperatively define a polygon are arranged in such a manner that orientations of the lighting elements of the lighting members change continuously along the peripheral direction of the polygon, which means that emitting directions of the lights of neighboring lighting members are different from each other, the lights of neighboring lighting members are interlaced with each other, the light spots of the lighting module are more even, and the shadow of an object illuminated by the flat lamp with such lighting module is close to of the object under the sun.

### BRIEF DESCRIPTION OF THE DRAWINGS

In order to illustrate technical solutions of embodiments of the present application more clearly, drawings that need to be used in the description of the embodiments will be briefly described below, It is obvious that the drawings described below are only some embodiments of the present application, and other drawings may be obtained from the drawings without any creative work to those skilled in the art, which should be in the scope of this application. In the following description, the same reference numerals refer to the same members.

FIG. 1 is a schematic, assembled view of a flat lamp provided by an embodiment of the present application.

FIG. 2 is a schematic, exploded view of the flat lamp provided by the embodiment of the present application.

FIG. 3 is a cross sectional view of the flat lamp provided by the embodiment of the present application.

FIG. 4 shows a lens of the flat lamp viewed from another aspect.

FIG. 5 is a plan view of a lighting module of the flat lamp provided by the embodiment of the present application.

FIG. 6 is a plan view of the lighting module of the flat lamp provided by another embodiment of the present application.

FIG. 7 is a simulation view showing a lighting effect of the flat lamp.

### DESCRIPTION OF THE EMBODIMENTS

For better illustrating the technical means, creative features, objects and effects of the present application, detailed description will be given for the embodiments provided by the present application with reference to the append drawings. Obviously, the described embodiments are only a part of the embodiments, and not all of the embodiments of the present application. Based on the embodiments of the present application, all other embodiments obtained by those skilled in the art without any creative work should be in the scope of this application.

It should be noted that when an element is referred to as being “fixed to” or “disposed in/at” another element, it may be directly or indirectly on the other element. When an element is referred to as being “connected to” another element, it may be directly or indirectly connected to the other element.

It should be understood that oriental or positional relationships indicated by terms “length”, “width”, “upper”, “lower”, “front”, “rear”, “left”, “right”, “vertical”, “horizontal”, “top”, “bottom”, “inner”, “outer” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure.

In addition, terms “first” and “second” are only used for descriptive purposes, and cannot be understood as indicating or implying relative importance or implicitly indicating the number of technical features indicated. Therefore, features defined with “first” and “second” may explicitly or implicitly include one or more of these features. In the description of the present disclosure, “a plurality of” refers to two or more than two, unless otherwise particularly defined.

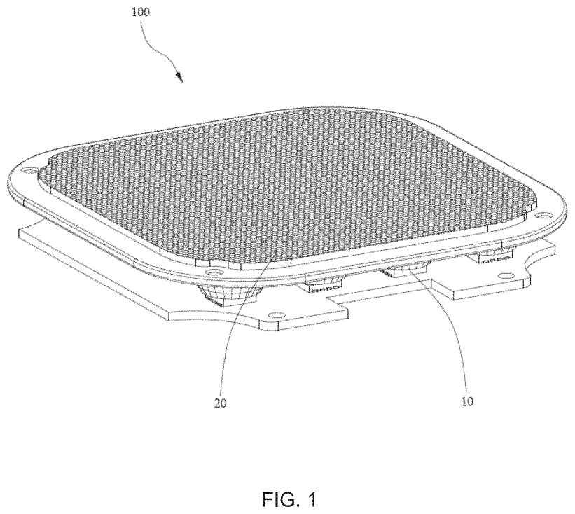

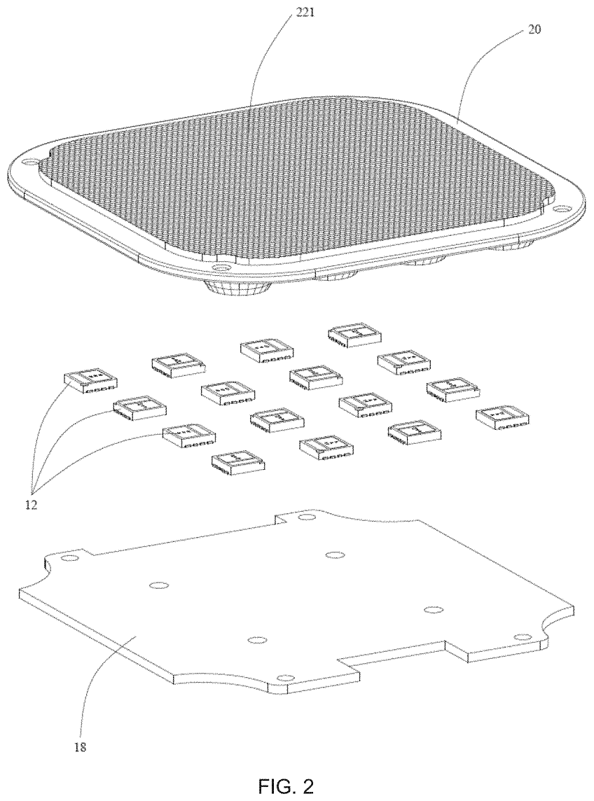

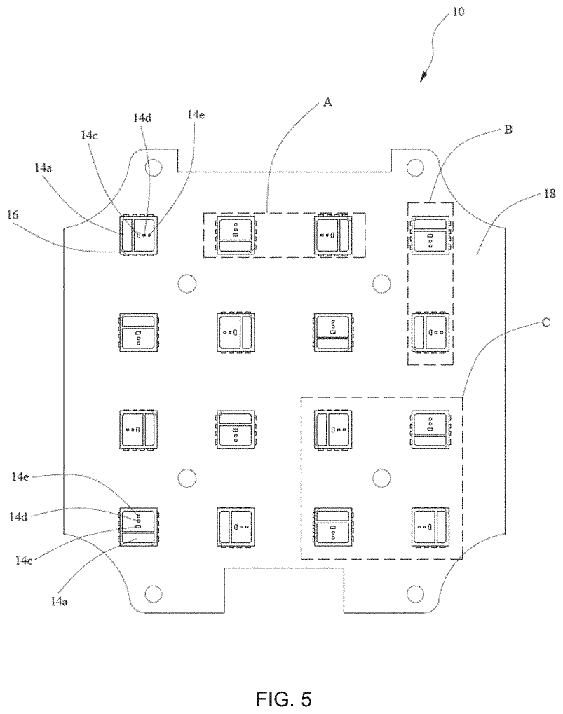

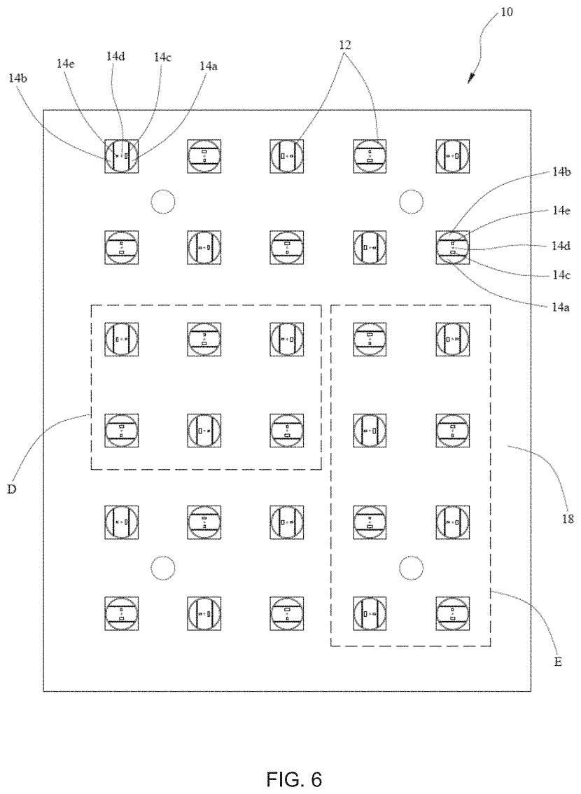

The present application provides a flat lamp 100, configured for illumination. Referring to FIG. 1 and FIG. 2, a flat lamp 100 according to an embodiment of the present application is shown. The flat lamp 100 includes a lighting module 10 and a lens 20 covering the lighting module 10. The lighting module 10 includes a plurality of lighting members 12 arranged in a matrix. Each of the lighting members 12 includes several lighting elements 14, and the lighting elements 14 are different from each other in color. In one embodiment, as shown in FIG. 5, the lighting members 12 may be arranged in a matrix of 4 rows and 4 columns. In another embodiment, as shown in FIG. 6, the lighting members 12 may be arranged in a matrix of 6 rows and 5 columns. Lights generated by the lighting members 12 pass through the lens 20 to illuminate the outside, and the lights will be refracted when they enter the lens 20 and exit the lens 20 due to the change of media.

The lighting member 12 may generate white light by cooperating of all lighting members thereof, or, may generate light of a specific color by cooperating of some of the lighting members 12 thereof. The lighting elements 14 of each lighting member 12 incudes a first lighting element 14a for emitting warm light and/or a second lighting element 14b for emitting cool white light. In some embodiments, the lighting elements 14 of each lighting member 12 may further include at least one of a third lighting element 14c for emitting red light, a fourth lighting element 14d for emitting green light, and a fifth lighting element 14e for emitting blue light. Each of the lighting elements 14 can be controlled separately, and thus variety of lighting effects can be obtained through the combination of the several lighting elements 14.

In one embodiment, as shown in FIG. 5, the lighting elements 14 of each lighting member 12 include four lighting elements, i.e., a first lighting element 14a, a third lighting element 14c, a fourth lighting element 14d and a fifth lighting element 14e. In another embodiment, as shown in FIG. 6, the lighting elements 14 of each lighting member 12 include five lighting elements, i.e., a first lighting element 14a, a second lighting element 14b, a third lighting element 14c, a fourth lighting element 14d and a fifth lighting element 14e. It should be understood that the lighting elements 14 of each lighting member 12 may be consist of a second lighting element 14b, a third lighting element 14c, a fourth lighting element 14d and a fifth lighting element 14e, or may be consist of a first lighting element 14a and a second lighting element 14b, which should not be limited by the specific embodiments. Further, each lighting member 12 may further include a lighting member for emitting light of other color, such as yellow color and etc.

In this embodiment, the lighting elements 14 are LED dies, and the LED dies are packaged on a base 16 to form the lighting member 12. The base 16 is provided with a plurality of pins, and the pins are electrically connected to the LED dies. In this embodiment, the lighting module further includes a substrate 18, and the substrate 18 preferably is a circuit board, and has circuits, such as control circuits, power supply circuits and etc. integrally formed therein. During assembly, the LEDs are arranged on the substrate 18 in a matrix, the pins of the lighting member 12 are welded to the welding points of the circuits of the substrate, fixing the lighting member 12 onto the substrate 18 and connecting lighting member 12 to the substrate electrically, realizing both physical and electrical connections.

In this embodiment, the lighting elements 14 are arranged on the base 16 in a line, with the first lighting element 14a and the second lighting element 14b near lateral sides of the base 16, while the third lighting element 14c, the fourth lighting element 14d and the fifth lighting element 14e between the first lighting element 14a and the second lighting element 14b. For each two neighboring lighting members 12 of the matrix, orientations thereof on the substrate 18 are different from each other. In other words, the lighting elements 14 of one lighting member 12 is different from that of the other lighting member 12, which means that light-emitting directions of the two neighboring lighting members 12 are different from each other.

In this embodiment, for each two neighboring lighting members 12 in the same row of the matrix, the orientations of the lighting elements 14 are perpendicular to each other. In other words, the lighting elements 14 of each lighting member 12 are arranged in a manner of rotating 90 degrees relative to that of the previous lighting member 12 in the same row. For example, for the two lighting members 12 surrounded by dotted box A of FIG. 5, the lighting elements 14 of the left lighting member 12 are placed at intervals along the vertical direction, while the lighting elements 14 of the right lighting member 12 are placed at intervals along the horizontal direction.

In this embodiment, for each two neighboring lighting members 12 in the same column of the matrix, the orientations of the lighting elements 14 are perpendicular to each other. That is, the lighting elements 14 of each lighting member 12 are arranged in a manner of rotating 90 degrees relative to that of the previous lighting member 12 in the same column. For example, for the two lighting members 12 surrounded by dotted box B of FIG. 5, the lighting elements 14 of the upper lighting member 12 are placed at intervals along the vertical direction, while the lighting elements 14 of the lower lighting member 12 are placed at intervals along the horizontal direction.

Further, each four neighboring lighting members 12, which cooperatively define a square, are arranged in a manner of a rotation matrix. For example, for the four lighting members 12 surrounded by dotted box C of FIG. 5, each lighting member 12 rotates 90 degrees relative to the neighboring lighting member 12 along the clockwise direction or anti-clockwise direction. In details, the lighting elements 14 of the lighting member 12 at the left, upper corner of the square are arranged in a direction from left to right; the lighting elements 14 of the lighting member 12 at the right upper corner of the square are arranged in a direction from bottom to top; the lighting elements 14 of the lighting member 12 at the right lower of the square are arranged in a direction from right to left; and the lighting elements 14 of the lighting member 12 at the left lower corner of the square are arranged in a direction from top to bottom.

Further, for neighboring lighting members 12 which cooperatively define a rectangle, such as six lighting members 12 surrounded by dotted box D of FIG. 6 or eight lighting members 12 surrounded by dotted box E of FIG. 6, each lighting member 12 rotates 90 degrees relative to the neighboring lighting member 12 along the peripheral direction of the rectangle. Thus, the lighting elements 14 of the lighting members 12 in the rectangle emitting the same color lights are substantially evenly arranged along the peripheral direction of the rectangle and have different orientations, the light spot of the lights of each color are more even, and the shadow of the illuminated object is close to that under the sun.

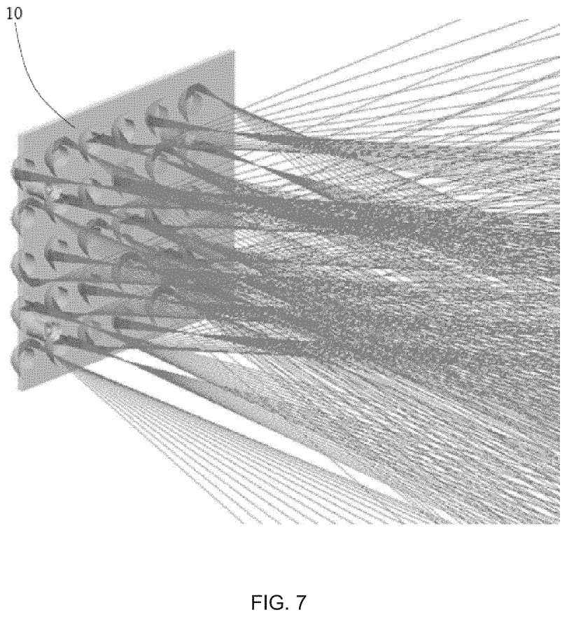

The lighting module 10 provided by the embodiment of the present application includes a plurality of lighting members 12 arranged in a manner of a rotation matrix, and the orientation of the lighting elements 14 of one lighting member 12 is different from that of the neighboring lighting member 12, thus the lights of neighboring lighting members 14 are interlaced with each other, and are refracted to different directions during passing through the lens 20, as shown in FIG. 7. Finally, the light spots of the lighting module 10 provided by the present application are more even, and the shadow of an object illuminated by the flat lamp 100 incorporating such lighting module 10 is close to that of the object under the sun.

In other embodiments, the lighting members 12 of the lighting module 10 may be arranged in such a manner that neighboring lighting members 12 which cooperatively define a regular hexagon are arranged in a manner of a rotation matrix. In this situation, each lighting member 12 may rotate 60 degrees relative to the neighboring lighting member 12 along the peripheral direction of the regular hexagon. Alternatively, the lighting members 12 may be arranged in such a manner that neighboring lighting members 12 which cooperatively define a regular octagon are arranged in a manner of a rotation matrix. In this situation, each lighting member 12 may rotate 45 degrees or 90 degrees relative to the neighboring lighting member 12 along the peripheral direction of the regular octagon.

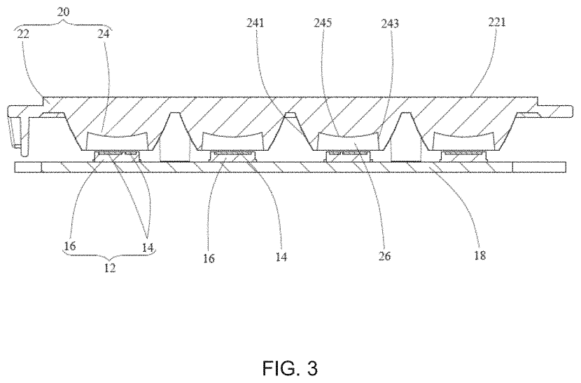

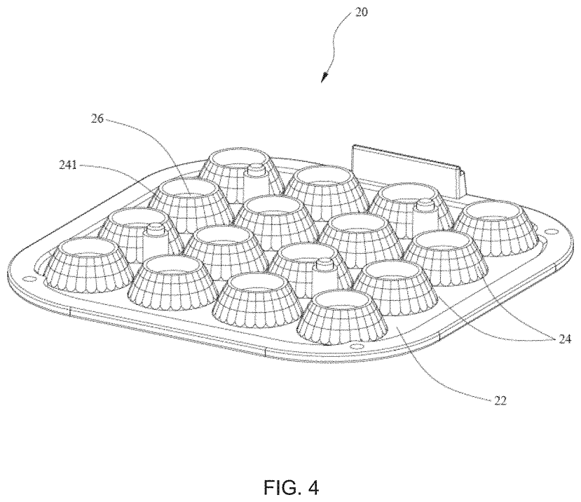

As shown in FIG. 3 and FIG. 4, the lens 20 covers all of the lighting members 12, and preferably is a total internal reflection lens or a convex lens. In this embodiment, the lens 20 includes a flat emitting portion 22 and a plurality of reflecting portions 24 protruding from an inner side of the emitting portion 22 towards the substrate 18. Each of the reflecting portions 24 defines a groove 26 receiving one of the lighting members 12 therein. The lights of the lighting member 12 enter into the reflecting portion 24 and then are reflected to the emitting portion 22. Mounting holes are defined in corresponding positions of the substrate 18 and the emitting portion 22 for fixing the lens 20 onto the substrate 18.

An outer side of the emitting portion 22, which functions as an emitting side 221 of the flat lamp 100, is preferably fish scale shaped, making the lights output of the flat lamp 100 more even. The reflecting portion 24 is generally truncated cone-shaped, and has an outer circumferential surface 241 generally being bowl-shaped. Preferably, the outer circumferential surface 241 of the reflecting portion 24 expands gradually along a direction away from the lighting member 12, which can reflect more lights towards the emitting portion 22, improve the emission rate of the lights. The outer circumferential surface 241 of the reflecting portion 24 is preferably a surface with high reflectivity, which makes the lights be reflected as much as possible, further improving the emission rate of the lights.

The groove 26 of the reflecting portions 24 is generally truncated cone-shaped, and has an inner circumferential surface 243 which surrounds the groove 26 generally being conical-shaped. Preferably, the inner circumferential surface 243 of the reflecting portion 24 expands gradually along a direction towards the lighting member 12, which can reduce the incidence angle of the lights of the lighting member 12, and thus improve the incidence rate of the lights. The inner circumferential surface 243 of the reflecting portion 24 is preferably a surface with high transmittance, which makes the lights enter into the lens 20 as much as possible, further improving the incidence rate of the lights.

In this embodiment, an inner surface 245 of the reflecting portion 24 at a bottom of the groove 26 faces the lighting member 12 directly. Preferably, the inner surface 245 of the reflecting portion 24 is convex towards the lighting member 12, which can diffuse the lights entering into the reflecting portion 24, making the lights output of the flat lamp 100 more even.

In some embodiment, the flat lamp 100 further includes a diffuser panel, which is placed at the emitting side 221 of the lens 20. The diffuser panel adjusts the light intensity refracted by the lens 20, so as to adjust the hard light projected by the lens 20 to soft light, thereby adapting to the current use environment.

The flat lamp 100 and the lighting module 10 provided by embodiments of the present application includes a plurality of lighting members 12 arranged in a manner of a matrix, and each of the lighting members 12 includes a plurality of lighting elements 14 for emitting lights of different colors. For each two neighboring lighting members 12, orientations of the lighting elements 14 thereof are different from each other. For neighboring lighting members 12 which cooperatively define a polygon, the orientations of the lighting elements 14 thereof change continuously along the peripheral direction of the polygon, which means that the lighting members 12 are arranged in a manner of a rotation matrix. The lights of neighboring lighting members 12 are interlaced with each other, the light spots of the lighting module 10 are more even, and the shadow of an object illuminated by the flat lamp 100 with such lighting module 10 is close to that of the object under the sun.

The above merely provides the preferred embodiments of the present disclosure, which is illustrative, rather than restrictive, to the present disclosure. However, it should he understood by those skilled in the art that, many variations, modifications even substitutions that do not depart from the spirit and scope defined by the present disclosure, shall fall into the extent of protection of the present disclosure.

What is claimed is:

1. A lighting module comprising:
a substrate; and
a plurality of lighting members arranged in a matrix on the substrate, each of the lighting members comprising a plurality of lighting elements for emitting lights of different colors, neighboring lighting members which cooperatively define a regular polygon being arranged in a manner of a rotation matrix.

2. The lighting module of claim 1, wherein each four neighboring lighting members which cooperatively define a square are arranged in a manner of a rotation matrix.

3. The lighting module of claim 2, wherein an orientation of the lighting elements of one lighting member rotates 90 degrees relative to that of the lighting elements of the neighboring lighting member.

4. The lighting module of claim 3, wherein the lighting elements of the lighting member comprises a first lighting element for emitting warm light and/or a second lighting element for emitting cool white light.

5. The lighting module of claim 4, wherein the lighting elements of the lighting member further comprises at least one of a third lighting element for emitting green light, a fourth lighting element for emitting red light, and a fifth lighting element for emitting blue light.

6. A lighting module comprising a plurality of lighting members arranged in a matrix, each of the lighting members comprising a plurality of lighting elements for emitting lights of different colors, the lighting elements of each of the lighting members being arranged in a line, for each two neighboring lighting members, an orientation of the lighting elements of one lighting member being different from that of the lighting elements of the other lighting member.

7. The lighting module of claim 6, wherein for two neighboring lighting members in each column of the matrix, the orientation direction of the lighting elements of one lighting member is perpendicular to that of the lighting elements of the other lighting member.

8. The lighting module of claim 6, wherein for two neighboring lighting members in each row of the matrix, the orientation of the lighting elements of one lighting member is perpendicular to that of the lighting elements of the other lighting member.

9. The lighting module of claim 6, wherein for neighboring lighting members which cooperatively define a regular polygon, the orientations of the lighting elements of the lighting members change continuously along the peripheral direction of the regular polygon.

10. The lighting module of claim 9, wherein for four neighboring lighting members which cooperatively define a square, the orientation of the lighting elements of each lighting member is different from that of the other three lighting members.

11. The lighting module of claim 6, wherein for neighboring lighting members which cooperatively define a rectangle, the orientation of the lighting elements of each lighting member rotates 90 degrees relative to that of the lighting elements of neighboring lighting member along the peripheral direction of the rectangle.

12. The lighting module of claim 6, wherein the lighting elements of the lighting member are LED dies, and comprises a first lighting element for emitting warm light and/or a second lighting element for emitting cool white light.

13. The lighting module of claim 12, wherein the lighting elements of the lighting member further comprises at least one of a third lighting element for emitting green light, a fourth lighting element for emitting red light, and a fifth lighting element for emitting blue light.

14. A flat lamp, comprising:
a substrate;
a plurality of lighting members arranged in a matrix on the substrate, each of the lighting members comprising a plurality of lighting elements for emitting lights of different colors, neighboring lighting members which are located at corners of a regular polygon being arranged in a manner of a rotation matrix; and
a lens covering the lighting members, the lens comprising a flat emitting portion through which the lights of the lighting elements pass to the outside.

15. The fiat lamp of claim 14, wherein the lens further comprises a plurality of reflecting portions protruding from an inner side of the emitting portion towards the substrate, and each of the reflecting portions defines a groove receiving one of the lighting members.

16. The flat lamp of claim 15, wherein an outer side of the emitting portion facing the outside is fish scale shaped.

17. The flat lamp of claim 15, wherein an inner surface of the reflecting portion at a bottom of the groove is convex towards the lighting member.

18. The flat lamp of claim 17, wherein an inner circumferential surface of the reflecting portion surrounding the groove expands gradually along a direction towards the lighting member; and an outer circumferential surface of the reflecting portion expands gradually along a direction away from the lighting member.

19. The flat lamp of claim 18, wherein the outer circumferential surface of the reflecting portion is bowl-shaped, and the inner circumferential surface of the reflecting portion is conical-shaped.

20. The flat lamp of claim 14, wherein the lens is a total internal reflection lens or a convex lens.
